(19) United States
(12) Patent Application Publication
(10) Pub. No.: US 2012/0107788 A1
(43) Pub. Date: May 3, 2012

(54) Rhythmic learning method

(76) Inventor: Alfred Nelson Green, III, Gilmer, TX (US)

(21) Appl. No.: 13/317,801

(22) Filed: Oct. 28, 2011

Related U.S. Application Data
(60) Provisional application No. 61/408,080, filed on Oct. 29, 2010.

(51) Int. Cl. G09B 3/00

(52) U.S. Cl. 434/350

(57) ABSTRACT

The current invention offers experiences that might be called “simulated music reading.” This curriculum delivery invention comprises a computer-operated instructional delivery system displaying pre-formatted curriculum content accompanied by animations that elicit rhythmic participation. The computer-controlled display (computer monitor, television, or projection screen) provides access to start/stop and tempo controls. The display also reveals cursors, arrows, shadings, and other animated features applied to curriculum material, ensuring that students perceive a prescribed rhythm and can give a choral response. Whether reciting, interpreting, identifying, or supplying missing content elements, the students' creation of and involvement in a rhythmic context is a key element of the invention's efficacy. In summary, the invention presents curriculum content while encouraging rhythmic brain experiences that are known to develop general creativity and enhance performance abilities in reading, math, geometry, music, and other high demand cerebral challenges.

### CROSS REFERENCE TO RELATED APPLICATIONS

This application claims the benefit of the following

U.S. Provisional Patent Application, which is incorporated herein in its entirety:

| | | | |
|---|---|---|---|
| Application No. | 61/408,080 | | |
| Docket No. | Ser. No. | Filing Date: | Title: |
| LY-9008676 | | Oct. 28, 2010 | |

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The current invention relates to Education and Demonstration (Unit 3715—Class 434) and a practical classroom use of computer animation technology.

In educational settings, the computer is widely used to display information, images, or movies to passive students. Computer technology has also allowed us to advance more confidently into individualized instruction, and animation is frequently used to enhance lessons for individuals. Computer animation holds great promise for classroom use if we consider the possibility that purposefully designed animation can create a learning environment. In such a classroom setting, students can experience situations that are otherwise outside the scope of traditional instructional methods.

The current invention allows the teacher to present curriculum elements or supervise practice of same in a classroom environment that enhances learning and evokes brain activity that is known to improve brain organization and cognitive function.

This innovation utilizes computer-controlled instructional innovations. One educational strategy that is incorporated into the efficacy of this invention is the use of limited time periods for student response. When this factor is a consistent characteristic of the learning environment, it imposes an experience on the brain which requires rapid recall and response. Just as other parts of the human anatomy adapt to experienced demands rather than to wishes or thoughts, the brain adapts best when placed in situations which demand more than it can currently perform. Simply trying to recall a known detail as quickly as possible because it is convenient to do so does not strongly influence the brain to function at a higher speed. But if the brain has one second to provide the answer and then it is drawn to another task, the brain must recognize its inability. If it is consistently faced with that dilemma, the brain will search for better and faster cerebral connections to meet that experienced demand. A consequent improvement of processing speed is inevitable. Time limits such as that described herein are an important means of imposing higher demands on the brain.

The current invention also introduces the idea that educational methodology can be designed and/or selected based on its value as a brain exercise tool. Just as the use of a treadmill, bench press, or stationary bicycle promotes physical health, certain activities are known to promote brain health. The recent discovery of lifelong cerebral plasticity implies the development of processes or exercises that can physiologically “rewire” the brain for new tasks, recovery from disabling injury/stroke, and improvement of performance due to congenital disability or other innate performance deficit. The current invention makes use of the latest and best brain research to encourage brain development while teaching standard academic curriculum material in a novel and beneficial way.

Rhythmic acuity (rhythmicity) has been found to be an important attribute of a highly functioning brain. This was first suggested by the discovery that musicians' brains develop differently than non-musicians' brains. Through research projects, it has been determined that rhythmic acuity is one attribute that contributes to high level brain function. The improvement of a student's rhythmicity has been shown to lessen the symptoms of ADD/ADHD, dyslexia, and even to moderate behavior characteristics of students diagnosed with disability within the autism spectrum. To date, most rhythmic activities that are purposefully designed to moderate cerebral deficit are only available as one-on-on therapies. Animated curriculum presentations which evoke rhythmic choral recitation can exercise the brain just as completely as custom designed rhythm-related private therapies.

Ongoing research that is accelerating due to advancements in functional magnetic resonance imaging will likely disclose other advantages of the cerebral development that the current method of instructional delivery offers. To date, each discovery substantiates the hypothesis of the brain's permanent plasticity and suggests that educators can shape and mold the brain beyond the common perception. When schools take responsibility for directing the brain's development in addition to providing access to knowledge, instructional delivery will move quickly in the direction proposed by the current invention.

### BRIEF SUMMARY OF THE INVENTION

The current innovation comprises an automated animated computer operated system of instructional delivery using an easily acquired computer and display system (projector screen, TV monitor, or other). The invention offers exposure to and practice on common curricular material within a context of rhythm-related brain development experiences. The rhythmic context is created by the students' choral recitation of the curricular material at a speed selected by the teacher and in a rhythm that is prescribed by the automated program. After minimal orientation to the system, even a very large class of students can participate beneficially. In such class size groups, students achieve an anonymity that allows each one to participate without fear of failure or social intimidation. Simultaneously, the teacher can circulate through the room and monitor each student for participation, rhythmicity, and accurate response. This dual-purpose curriculum allows educators to teach traditional material while working the brain in ways that are known to develop brain connections required for any creative endeavor as well as success in the traditional disciplines of reading, math, geometry, music, and other cerebral challenges.

### BRIEF DESCRIPTION OF THE SEVERAL VIEWS OF THE DRAWINGS

Not applicable

### DETAILED DESCRIPTION OF THE INVENTION

In our nations schools, there is an increasing urgency to teach the commonly accepted (ubiquitously tested) curriculum. In that process, we assume a lot. Among those assumptions is the expectation that students develop brain power and increased cognitive abilities naturally and without encouragement or assistance from environmental factors that the school can control. With that assumption, educators usually adopt the strategy of simply supplying the curricular information in various forms.

Because the brain is the center of our self-awareness and is less evident to ourselves than are other parts of our person, we perceive the brain to be complete and fully formed. The field of neurological science is learning that the human brain is no less an organ than the heart, the lungs, or a weak limb that requires strengthening. Therefore, like the rest of our body, the brain responds to a load (exercise or stimulation) by developing capabilities in the specific direction of the demand. With the help of scientific advancement, we have learned that the brain maintains a remarkable plasticity (ability to change) throughout a person's life and can be developed through specific activities and mental challenges.

Research has shown that one of the most important characteristics of a highly functioning brain is synchronicity. That is, a firing neuron must have the attention of a receiving neuron at precisely the right instant or that brain activity is lost and cannot be passed on to finalize a thought, initiate an action, or advance the understanding of a concept. One of the primary means of developing synchronicity is improvement of rhythmic acuity (rhythmicity). Therefore, developing a high level of internal rhythmicity and awareness of synchronicity is one of the most effective means to organize the brain for proper and efficient functioning. Developing those internal habits of mind is a primary goal of this innovation.

Similarly, we have learned that our brain grasps information best when it is engaged and when urgency accompanies the learning attempt. When a rhythm component is added to learning exercises, students often grasp mundane details with ease as the brain experiences the need to respond quickly or lose the opportunity to respond. This sort of activity is not only engaging, it conveys urgency to the brain, so the brain is more likely to accept and act on the request for rapid learning, recall, and response.

The current invention is comprised of curriculum material presented in an animated context that stresses rhythmic brain activity. The following is a single screen of one such exercise and is not intended to demonstrate an exclusive use of this invention.

### Screen 1:

1+1=?

With the aid of animated cursors, arrows, and shading to indicate when to recite each character, a class of students reads the characters in that equation aloud in choral style, but they would supply the sum of 1+1 in place of “?.” The result is a chant which establishes an auditory rhythm that corresponds with the visual cues (animated cursors, arrows, and shading) of the presentation. The next screen would appear in exactly the rhythm established by the cursors, arrows, and shading in the first screen. It would be identical to the first screen except that the correct answer (2) would appear in place of the “?.”

### Screen 2:

1+1=2

The students would be silent while seeing the correct answer (Screen 2) and evaluating their performance. The next screen (new material) would follow immediately in the established rhythm so that each student must redirect mental energy toward a new task. This process reinforces curricular understanding, develops rapid processing skills, and orients the brain to rhythmic functioning.

There are few limits to the type of learning this method could address. Following are examples of material in a variety of subjects that can be treated in this way. These examples are not intended to demonstrate an exclusive use of this invention:

Grammar study (parts of speech) might take a form such as this example which is not intended to demonstrate an exclusive use of this invention:

### Parts of Speech Screen 1:

The name of a person is a ______.

Following the rhythmic recitation of that screen with the answer (“proper noun”) in the blanks, the next screen would appear:

### Parts of Speech Screen 2:

The name of a person is a proper noun.

As before, the next screen of new material would appear in rhythm so that the brain must move on and is encouraged to develop skills of rapid processing and recall.

Science study might take a form such as this example which is not intended to demonstrate an exclusive use of this invention:

### Science Screen 1:

Ben Franklin proved that lightning is ______.

Following the rhythmic recitation of that screen with the answer (“electricity”) in the blanks, the next screen would be:

### Science Screen 2:

Ben Franklin proved that lightning is electricity.

As before, the next screen of new material would appear in rhythm so that the brain must move on and is encouraged to develop skills of rapid processing and recall.

Social Studies class might experience this example which is not intended to demonstrate an exclusive use of this invention:

### Social Studies Screen 1:

The continent east of Europe is ______.

Following the rhythmic recitation of that screen with the answer (“Asia”) in the blank, the next screen would be:

### Social Studies Screen 2:

The continent east of Europe is Asia.

As before, the next screen of new material would appear in rhythm so that the brain must move on and is encouraged to develop skills of rapid processing and recall.

Music study might take a form such as this example which is not intended to demonstrate an exclusive use of this invention:

### Music Screen 1:

The most famous lullaby was written by ______.

Following the rhythmic recitation of that screen with the answer (“Brahms”) in the blank, the next screen would be:

### Music Screen 2:

The most famous lullaby was written by Brahms.

As before, the next screen of new material would appear in rhythm so that the brain must move on and is encouraged to develop skills of rapid processing and recall.

Physical Education study might take a form such as this example which is not intended to demonstrate an exclusive use of this invention:

### Physical Education Screen 1:

The number of baseball players playing for each team is ______.

Following the rhythmic recitation of that screen with the answer (“9”) in the blanks, the next screen would be:

### Physical Education Screen 2:

The number of baseball players playing for each team is 9.

As before, the next screen of new material would appear in rhythm so that the brain must move on and is encouraged to develop skills of rapid processing and recall.

In addition to fill-in-the-blank responses, similar benefits accrue to students who respond to a format that only allows the student time to state the answer before the next question appears. With the use of visual cues, a rhythm is established so that the class has little time (often less than one second) to view and process each question before stating only the answer as a choral recitation. This is most easily demonstrated in a math context.

The following example is of consecutive screens with approximately one-half second between screens and is not intended to demonstrate an exclusive use of this invention:

### Math Screen 1:

5−3=?

### Math Screen 2:

8+7=?

### Math Screen 3:

9+6=?

### Math Screen 4:

2+4=?

### Math Screen 5:

10−3=?

### Math Screen 6:

4×4=?

### Etc.

Other possibilities include visual discrimination tasks that are required for success in any subject. The first example below is a list of simple “sight words,” or words that must be readily identified without the need for phonetic study or other logical processing. The following is an example of consecutive screens with approximately one-half second between screens and is not intended to demonstrate an exclusive use of this invention:

### Sight Words Screen 1:

the

### Sight Words Screen 2:

and

### Sight Words Screen 3:

at

### Sight Words Screen 4:

after

### Sight Words Screen 5:

leave

### Sight Words Screen 6:

on

### Etc.

Another example is the identification of objects from pictures or images that are presented on the computer display. An exercise such as this might be required knowledge in kindergarten class or English as a Second Language class. The students recite the name of the item from pictures, which cannot be replicated in text:

The following is an example of consecutive screens with approximately one-half second between screens and is not intended to demonstrate an exclusive use of this invention:

### Images Screen 1:

desk (image)

### Images Screen 2:

pencil (image)

### Images Screen 3:

book (image)

### Images Screen 4:

notebook (image)

### Images Screen 5:

computer (image)

### Images Screen 6:

stapler (image)

### Etc.

The plurality of topics and the variations in the animation format that are possible in such a presentation and response format may be without limit.

I claim:

1. A computer-controlled automated instructional method for teaching any curriculum to a classroom of students, with the method comprising the steps in the sequence set forth:
a. Positioning the class before a computer display such as a monitor, big screen television, or projector screen and ensuring that each student has an unobstructed view of said display;
b. Displaying instructions for the instructional unit at hand;
c. Setting the speed of the instructional unit as appropriate for the class and the difficulty of the curriculum;
d. Directing the students' attention to the display and requesting that they engage in choral recitation as indicated by the automated program with special attention to rhythmic continuity and accuracy;
e. Displaying the first equation, incomplete sentence, image, or series of images;
f. Starting the automated program (computer controlled) and ensuring that the class begins the choral recitation with strict attention to rhythmic precision as indicated by the visual cues provided by the program's animated cursors, arrows, shadings, and other animated objects;
g. Monitoring the class and each student therein to ascertain the level of attending, the attention to rhythmic precision, the boldness of participation, and the accuracy of response;
h. Repeating steps (b)-(g) with the same or different instructional unit and with modifications of speed, difficulty of material, and other factors as indicated by the previous experience.

2. A computer-controlled automated classroom instructional method for enhancing curricular learning comprising the critical attributes listed:
a. Moving rapidly through large volumes of curriculum material;
b. Moving rhythmically beyond each student response so that the brain experiences the need to provide rapid recall and response;
c. Repeating instructional units as necessary to provide appropriate amounts of review and practice.

3. A computer-controlled automated classroom instructional method for encouraging synaptic synchronicity, brain organization, and brain development by means of the critical attributes listed:
a. Distinct and precise choral recitation with a well-defined rhythmic pulse that is synchronized with the visual cues provided by the automated program;
b. In the context of the classroom activity, working with individual students to improve rhythmic acuity as the need becomes apparent.
